(19) United States
(12) Patent Application Publication
(10) Pub. No.: US 2015/0149446 A1
(43) Pub. Date: May 28, 2015

(54) CIRCUITRY FOR A COMPUTING SYSTEM AND COMPUTING SYSTEM

(71) Applicants: Ziv Zamsky, Ra'anana (IL); Dmitry Flat, Petah Tikva (IL); Kostantin Godin, Hertzelia (IL); Itay Peled, Hod Hasharon (IL)

(72) Inventors: Ziv Zamsky, Ra'anana (IL); Dmitry Flat, Petah Tikva (IL); Kostantin Godin, Hertzelia (IL); Itay Peled, Hod Hasharon (IL)

(73) Assignee: Freescale Semiconductor, Inc., Austin, TX (US)

(21) Appl. No.: 14/415,971

(22) PCT Filed: Jul. 27, 2012
(86) PCT No.: PCT/IB2012/053865

§ 371 Date: Jan. 20, 2015

(51) Int. Cl. G06F 17/30

(52) U.S. Cl. CPC G06F 17/30554
USPC 707/722

(57) ABSTRACT

Circuitry for a computing system includes a memory arrangement having at least one memory management unit and at least one processor. The at least one processor is arranged to issue a memory query to the memory management unit. The memory management unit is arranged to provide a query result in response to the memory query directly to the processor via a data connection.

### FIELD OF THE INVENTION

This invention relates to a circuitry for a computing system and a computing system.

### BACKGROUND OF THE INVENTION

Modern computing systems have highly complex address and memory arrangements. In many cases there is provided a virtual address space to which physical addresses of different system components and peripheral devices are mapped. Usually, a memory management unit is provided to manage the virtual address space and to translate physical addresses into virtual addresses and vice versa.

### SUMMARY OF THE INVENTION

The present invention provides a circuitry for a computing system and a computing system as described in the accompanying claims.

Specific embodiments of the invention are set forth in the dependent claims.

These and other aspects of the invention will be apparent from and elucidated with reference to the embodiments described hereinafter.

### BRIEF DESCRIPTION OF THE DRAWINGS

Further details, aspects and embodiments of the invention will be described, by way of example only, with reference to the drawings. In the drawings, like reference numbers are used to identify like or functionally similar elements. Elements in the figures are illustrated for simplicity and clarity and have not necessarily been drawn to scale.

FIG. 1 schematically shows an example of an embodiment of circuitry for a computing system

FIG. 2 schematically shows an example of a computing system.

### DETAILED DESCRIPTION OF THE PREFERRED EMBODIMENTS

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

In the following, the term address may generally refer to a virtual address or a physical address. It should be noted that physical addresses may be mapped to virtual addresses and vice versa such that a virtual address may represent a physical address and vice versa.

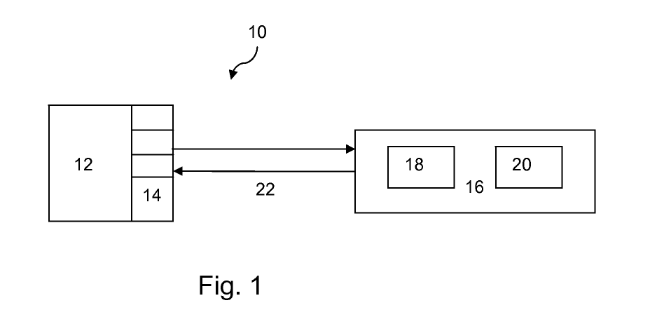

FIG. 1 schematically shows an example of a circuitry 10 for a computing system. It may be envisioned that the computing system is or comprises a digital signal processor, a microprocessor and/or a microcontroller. The circuitry 10 may generally comprise at least one processor 12. The processor 12 may comprise one or more processor cores. It may be considered that the at least one processor 12 comprises one or more processor registers 14, which may also be called core registers. The processor registers 14 may comprise, e.g., a stack pointer and/or a program counter and/or a link register and/or one or more program status registers and/or one or more general purpose registers. The processor 12 may be arranged to directly access the processor registers 14 without interaction with a register management unit or memory management unit.

The circuitry 10 may comprise a memory arrangement 16, which may comprise at least one memory management unit 18 and at least one memory 20. The at least one memory management unit 18 may generally be arranged to manage a virtual address system, in particular to map physical addresses of memory and/or addressable components and/or peripheral devices to virtual addresses and vice versa, and/or to provide cache status information and/or memory attributes. The memory 20 may comprise one or more devices addressable by or via the memory management unit 18, e.g., cache memory, in particular a level 1 cache memory, which may be an instruction cache, a data cache or a combined cache, RAM, graphic devices, audio devices and/or generally peripheral devices. It may be considered that the memory management unit 18 comprises one or more sub-units. There may be one or more memory registers associated to the memory management unit 18, which may be accessible to the memory management unit 18 and/or the processor 12. In particular, it may be envisioned that the at least one memory management unit 18 comprises a data memory management unit and/or an instruction memory management unit of a cache memory arrangement comprising an instruction cache and/or a data cache. The cache memory arrangement may be a level 1 cache.

The memory arrangement 16 and the processor may be connected by a data connection 22, which may be a data bus. The data connection 22 may be bidirectional or it may comprise at least two unidirectional connections. The at least one processor 12 may be arranged to issue a memory query to the memory management unit 18. It may be considered that the memory query is issued via the data connection 22. A memory query may generally be represented by a single instruction. It may be considered that the memory management unit 18 is connected to the processor 12 via the data connection 22. A memory register may be accessible to the processor 12 via the data connection 22. A processor register 14 may be considered to be a register accessible to the process without requiring reception of data from the data connection 22 and/or without interaction with the memory management unit 18.

It may be envisioned that a memory query refers to a status of the memory, in particular to a physical or virtual address. A memory query may generally refer to a translation of a physical address to a virtual address or vice versa and/or to the status or characteristics of a physical or virtual address and/or to cache status information and/or memory attributes.

The memory management unit 18 may be arranged to receive the memory query via data connection 22. It may be considered that the memory management unit 18 is arranged to provide a query result in response to the memory query. The memory management unit 18 may be arranged to provide the query result directly to the processor 12 via the data connection 22. The query result may comprise a translated address and/or status information of one or more addresses and/or characteristics of one or more addresses or devices associated to the addresses and/or cache status information and/or one or more memory attributes. Generally, the memory management unit 18 may be arranged to control providing the query result, in particular to translate a virtual address into a physical address and/or vice versa and/or to provide status information and/or characteristics and/or memory attributes, and/or to send the query result to the processor 12 via data connection 22. Directly providing a query result may refer to the memory management unit 18 being arranged to send the query result to the processor without first storing it in a memory register and/or without the processor 12 having to actively read out a memory register or memory address via the data connection 22. Rather, the memory management unit 18 may be arranged to treat a memory query like a load access by the processor 12, in which a query result is directly provided to the data connection 22 and/or to the processor via the data connection 22 without storing it in a memory register or memory address before it is transferred to and/or via the data connection 22. It may be considered that the memory query is performed like a load or read access to the memory 20 by the processor 12, such that the processor 12 does not have to access non-processor registers like memory registers or other memory to obtain a query result, but the query result is directly provided via data connection 22.

The processor 12 may be arranged to receive the query result via data connection 22. In particular, the processor 12 may be arranged to receive the query result in one or more than one processor registers 14.

Generally, it may be envisioned that the circuitry 10, in particular the processor 12, the memory management unit 18 and/or the memory 20 and/or the data connection 22 are implemented as an integrated circuit and/or are implemented on the same chip or die. In particular, a level 1 cache arrangement may be implemented in one integrated circuit comprising the processor 12. The processor 12 may in particular be a digital signal processor, a microprocessor and/or a microcontroller. It may be feasible that a processor or processor core is part of more than one circuitries as described herein, e.g., if it is connected via different data connections to different memory management units.

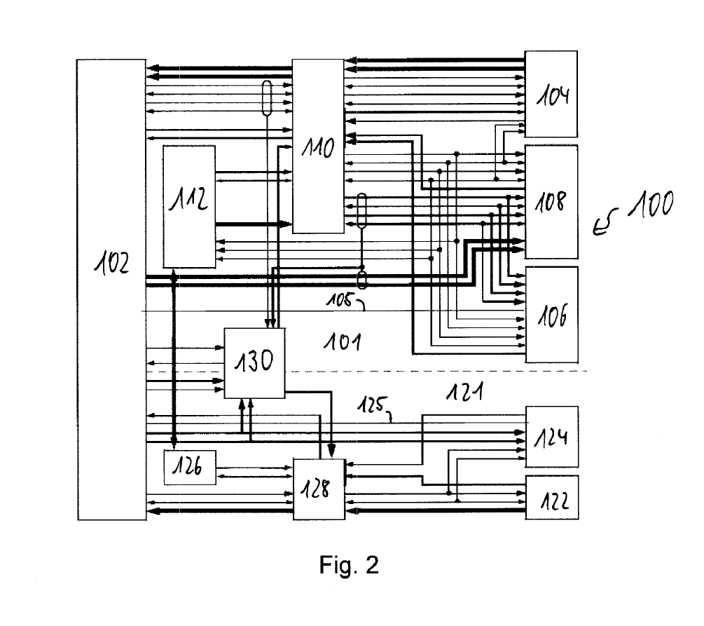

FIG. 2 schematically shows an example of a computing system 100. It may be contemplated that computing system 100 comprises at least one processor core 102. It may be feasible to implement computing system 100 as a microprocessor arrangement, a digital signal processor and/or a microcontroller. The computing system 100 may comprise a level 1 cache arrangement. A level 1 cache arrangement may generally comprise separate instruction and data caches. In particular, the computing system may comprise a data cache 104. There may be provided a data memory management unit 106 associated to the data cache 104. The data memory management unit 106 may be connected for data transfer with processor core 102 via a data connection 105, which may comprise unidirectional lines in both data transfer direction and/or bidirectional lines. It may be envisioned to provide one or more additional data cache control units 108, 110, 112 arranged for managing data flows from and to the data cache 104 and/or for detecting and managing cache misses and/or controlling the functions and communications of the data cache 104. Data lines may be provided to connect the data cache 104 to its associated devices 106, 108, 110 and/or to connect the associated devices to each other and/or to the processor core 102. The data cache 104 and its associated components 106, 108, 110 may be arranged to form parts of a data cache plane 101. The may be provided an instruction cache plane 121. The instruction cache plane 121 may comprise an instruction cache 122. An instruction memory management unit 124 may be associated to the instruction cache 122. The instruction memory management unit 124 may be connected for data transfer with processor core 102 via a data connection 125, which may comprise unidirectional lines in both data transfer direction and/or bidirectional lines. The instruction cache plane 121 may further comprise one or more additional devices 126, 128 arranged for managing data flows from and to the instruction cache 122 and/or for detecting and managing cache misses and/or controlling the functions and communications of the instruction cache 122. It may be envisioned that data lines are provided to connect the instruction cache 122 to its associated devices 126, 128 and/or to connect the associated devices 126, 128 to each other and/or to the processor core 102. There may be provided data lines connecting components of the instruction cache plane 121 with elements of the data cache plane 101 for data transfer. A data transfer unit 130 may be part of the computing arrangement 100. The data transfer unit 130 may be connected via suitable lines to components of the instruction cache plane 121 and/or the data cache plane 101. Components of the data cache plane 101 and/or the instruction cache plane 121 may be connected to the processor core 102 via suitable lines for transferring data. It may be considered that the data memory management unit 106 and/or the instruction memory management unit 124 is arranged to be part of a circuitry 10 as described above. In particular, it may be considered that the processor core 102 is arranged to issue a memory query to the data management unit 106 via the data connection 105 connecting it to the data management memory unit 106. It may be envisioned that the processor core 102 is arranged to receive a query result from the data memory management unit 106 via the data connection 105. Additionally or alternatively, the processor core 102 may be arranged to issue a memory query to the instruction memory management unit 124 via data connection 125. It may be envisioned that the processor core 102 is arranged to receive a query result from the instruction memory management unit 124 via data connection 125. As such, the combination of processor core 102, instruction memory management unit 124 and data connection 125 and the combination of processor core 102, data memory management unit 106 and data connection 105, respectively, may be considered to be forming a circuitry 10 as outlined above.

The circuitry and computing system described herein provides allows quick resolution of memory queries. Due to the memory management unit directly providing the query result, it is not necessary to provide memory barriers ensuring that a query has been performed and that the query result may be read from a memory register of the memory management unit. Accordingly, the computing system has a low amount of overhead for memory queries, which may of particular advantage in the context of tasks switches or accessing peripheral devices. It may be considered to provide the processor and/or the memory management unit with circuitry and/or commands to implement an instruction providing the described memory query and the query result.

The computing system may generally be any kind of system comprising a processor. It may be considered that the computing system is a bare-bone system, which may be extended by additional components. The computing system may be a System-on-a-Chip, a mobile system, e.g., a handheld device like a smartphone, a mobile phone or a tablet, a netbook or laptop, a desktop system or workstation. The computing system may comprise one or more processors. A processor may a single-core or multi-core processor, for example an ARM-based processor, a Power-based processor, an x86-based processor or a processor of the SPARC family or a digital signal processor. The computing system may be implemented as a microprocessor and/or microcontroller. The memory management unit may be representative of a memory management device or system comprising one or more sub-units or sub-devices. A memory management unit may be arranged to manage a cache, in particular a level 1 cache, and in particular may be arranged to provide cache status information and/or memory attributes as a query result. The memory may be a cache memory, in particular a level 1 cache memory. The cache memory of a level 1 cache may be separated into an instruction cache and a data cache, which may have associated to them individual memory management units, or it may be a combined instruction/data cache. The computing system may for instance include at least one processing unit, in particular a digital signal processor with one or more cores, associated memory and a number of input/output (I/O) devices. When executing a computer program, the computing system processes information according to the computer program and produces resultant output information via I/O devices.

In the foregoing specification, the invention has been described with reference to specific examples of embodiments of the invention. It will, however, be evident that various modifications and changes may be made therein without departing from the broader spirit and scope of the invention as set forth in the appended claims.

The connections as discussed herein may be any type of connection suitable to transfer signals from or to the respective nodes, units or devices, for example via intermediate devices. Accordingly, unless implied or stated otherwise, the connections may for example be direct connections or indirect connections. The connections may be illustrated or described in reference to being a single connection, a plurality of connections, unidirectional connections, or bidirectional connections. However, different embodiments may vary the implementation of the connections. For example, separate unidirectional connections may be used rather than bidirectional connections and vice versa. Also, plurality of connections may be replaced with a single connection that transfer multiple signals serially or in a time multiplexed manner. Likewise, single connections carrying multiple signals may be separated out into various different connections carrying subsets of these signals. Therefore, many options exist for transferring signals. It may be considered that the data connection is a memory bus connecting the processor to the memory arrangement.

Any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Also for example, in one embodiment, the illustrated examples may be implemented as circuitry located on a single integrated circuit or within a same device. For example, the processor registers may be implemented together with the processor. Alternatively, the examples may be implemented as any number of separate integrated circuits or separate devices interconnected with each other in a suitable manner. For example, the memory management unit may be connected to the memory and/or further components.

Also for example, the examples, or portions thereof, may implemented as soft or code representations of physical circuitry or of logical representations convertible into physical circuitry, such as in a hardware description language of any appropriate type.

Also, the invention is not limited to physical devices or units implemented in non-programmable hardware but can also be applied in programmable devices or units able to perform the desired device functions by operating in accordance with suitable program code, such as mainframes, minicomputers, servers, workstations, personal computers, notepads, personal digital assistants, electronic games, automotive and other embedded systems, cell phones and various other wireless devices, commonly denoted in this application as ‘computing systems’.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements The mere fact that certain measures are recited in mutually different claims does not indicate that a combination of these measures cannot be used to advantage.

1. A circuitry for a computing system comprising:
a memory arrangement having at least one memory management unit;
at least one processor;
the at least one processor being arranged to issue a memory query to the memory management unit;
the memory management unit being arranged to provide a query result in response to the memory query directly to the processor via a data connection.

2. The circuitry according to claim 1, the processor comprising one or more processor registers.

3. The circuitry according to claim 2, the processor being arranged to receive the query result in at least one of the processor registers.

4. The circuitry according to claim 1, the memory management unit being arranged to control providing the query result.

5. The circuitry according claim 1, the memory query being represented by a single instruction.

6. The circuitry according to claim 1, the memory management unit being arranged to perform at least one of manage a virtual address space or translate a virtual address into a physical address or vice versa.

7. A computing system comprising at least one circuitry according to claim 1.

8. The computing system according to claim 7, wherein the processor is a digital signal processor or a microprocessor.

9. The computing system according to claim 7, the computing system being implemented as a microcontroller.

10. The circuitry according to claim 1, wherein the memory management unit is configured to provide the query result directly to the processor without storing the query result in the memory management unit prior to providing the query result via the data connection.

11. In a computing system having a memory management unit and at least one processor, a method comprises:
issuing a memory query by the at least one processor to the memory management unit; and
providing a query result, by the memory management unit, in response to the memory query directly to the processor via a data connection.

12. The method according to claim 11, wherein the memory query is represented by a single instruction.

13. The method according to claim 11, further comprising:
translating between a virtual address and a physical address to provide the query result in response to the memory query.

14. The method according to claim 11, further comprising:
managing a virtual address space to provide the query result in response to the memory query.

15. The method according to claim 11, wherein providing the query result directly to the processor via the data connection is performed without storing the query result in the memory management unit.
